(19) United States
(12) Patent Application Publication
(10) Pub. No.: US 2009/0011786 A1
(43) Pub. Date: Jan. 8, 2009

(54) METHOD AND APPARATUS FOR CONTROLLING POWER FOR TRANSMISSION OF A PREAMBLE IN A MOBILE COMMUNICATION SYSTEM

(75) Inventors: Jang Bok LEE, Yongin-si (KR); Chang Ho SOHN, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/144,904

(22) Filed: Jun. 24, 2008

(30) Foreign Application Priority Data
Jul. 4, 2007 (KR) 2007-0067014

(51) Int. Cl. H04Q 7/20

(52) U.S. Cl. 455/522

(57) ABSTRACT

A method and an apparatus for controlling power for transmission of a preamble for acquisition of a channel are provided. The method for controlling power for transmission of a preamble includes calculating an initial preamble transmission power using an initial power calculated using information broadcast through a forward common channel and a stored difference value, transmitting the preamble through a backward common channel with the initial preamble transmission power and replacing the stored difference by a difference obtained by subtracting the initial power from the initial preamble transmission power and storing the obtained difference instead of the stored difference, when an acknowledge to the preamble is received.

### PRIORITY

This application claims the benefit under 35 U.S.C. §119(a) of a Korean patent application filed in the Korean Intellectual Property Office on Jul. 4, 2007 and assigned Serial No. 2007-0067014, the entire disclosure of which is hereby incorporated by reference.

### BACKGROUND OF THE INVENTION

1. Field of the Invention

The present invention relates generally to a control of power for transmission of a preamble in a mobile communication system. More particularly, the present invention relates to a method and an apparatus for controlling power for transmission of a preamble for acquisition of a channel.

2. Description of the Related Art

Conventionally, when data, arbitrarily generated in the user equipment of a mobile communication system, for example a terminal, is to be transmitted to a base station, it may be transmitted to a backward channel using a random access channel (hereinafter, referred to as ‘RACH’). The RACH is not a specific channel, for example one dedicated only for specific terminal, but is instead a common channel that may be approached and used by any of a plurality of terminals and may be arbitrarily approached by any terminal that is generating transmission data so that the terminal can acquire a channel to transmit the data. Since an RACH is a common channel that is accessible by a plurality of terminals, when one terminal desires to transmit data using the RACH, the terminal requests confirmation of an accessibility of the RACH from a base station. That is, after a terminal, that is to acquire an RACH, transmits a preamble of a predetermined length to a base station, it waits for an acknowledge (hereinafter, referred to as ‘ACK’) from the base station. An ACK to the RACH preamble is received through an Acquisition Indication CHannel (AICH) that is generally a forward channel. Generally, after a terminal transmits an RACH preamble using an arbitrary one of signatures for a plurality of RACHs, it transmits a message when an ACK to the transmitted RACH preamble is received.

If the terminal receives an ACK from a base station, it is provided access to the RACH and transmits data through the RACH. On the other hand, if the terminal does not receive an ACK from the base station for a preset period of time, it determines that the base station did not receive a preamble, and retransmits the preamble by increasing the power for transmission of the preamble. Retransmission of the preamble is continued until an ACK, informing the terminal that the preamble has successfully reached the base station, is received. For this purpose, the terminal transmits a preamble using information contained in a system information block (hereinafter, referred to as ‘SIB’). That is, the terminal calculates an initial preamble power for transmission of the preamble using the information contained in the SIB, and transmits the preamble with the calculated initial preamble power. Then, if the terminal does not receive an ACK to the preamble for a preset period of time, it increases the power for transmission of the preamble by a preset power, and retransmits the preamble with the increased power. Information regarding the preset power by which the power for transmission of a preamble is increased is also contained in the SIB when the preamble is received. In this way, the terminal retransmits a preamble until an ACK is received from a base station. Then, the number of retransmissions cannot exceed a maximum number of retransmissions that is contained in the SIB. An SIB contains information transmitted to all terminals in a cell through a broadcasting channel (BCH) from a base station. The terminal stores a received SIB and uses information contained in the SIB if necessary, and transmits a preamble using the following parameters contained in the SIB.

The parameters used for transmission of a preamble include a primary common pilot channel transmission power (primaryCPICH-TX-Power), a constant value (constantValue), an uplink interference (ul-Interference), an increased power (powerRampStep), a maximum number of retransmissions (preambleRetransMax), and a maximum number of cycles (Mmax). The primary common pilot channel transmission power is a value for informing a preamble transmission power of a reference channel with a common pilot channel for transmission of phase information regarding a wireless channel functioning as the reference channel. The uplink interference is an interference value with an adjacent cell in a backward channel. The constant value is a value representing a predetermined constant.

In order that a preamble can successfully reach a base station, it is necessary to properly control the power of transmission of the preamble, and the power of transmission of a preamble to acquire an RACH is controlled by a terminal. A terminal controls the power of transmission of a preamble using information contained in an SIB. More particularly, after a terminal calculates an initial preamble power using parameters contained in an SIB, it transmits the preamble with the calculated initial preamble power. If the terminal does not receive an ACK to the transmitted preamble, it increases the power for transmission of the preamble by a preset power, and retransmits the preamble using the increased power. The initial preamble power is calculated using Formula 1. In Formula 1, primaryCPICH-TX-Power is a preamble transmission power for a reference channel, ul-Interference is an interference value in a backward channel, and constantValue is a preset constant. A CPICH received signal code power (CPICH-RSCP) is a parameter representing a power of a signal received by a common pilot channel, and is measured by a terminal.

Initial-Preamble-Power=primaryCPICH-TX-Power−CPICH-RSCP+ul-Interference+constantValue Formula 1

A terminal transmits a preamble with the initial preamble power calculated in Formula 1. If the terminal does not receive an ACK to the preamble, it increases the power for transmission of the preamble by a preset power, and retransmits the preamble using the increased power. The power for retransmission of a preamble is calculated using Formula 2. In Formula 2, powerRampStep represents an increased power and preambleRetransMax represents a maximum number of retransmissions.

P(n)=Initial-Preamble-Power+powerRampStep×(n−1), (0<n≦preambleRetransMax) Formula 2

If the terminal does not receive an ACK from a base station, it repeats retransmissions of the preamble with the power calculated in Formula 2 up to a maximum number of retransmissions.

FIG. 1 is a view illustrating powers for transmissions of a preamble in a conventional system.

Referring to FIG. 1, if a terminal generates data, it transmits a preamble to a base station with an initial preamble power 110 that is calculated using Formula 1 in order to acquire an RACH. If the terminal does not receive an ACK to the transmitted preamble from the base station, it retransmits the preamble with a power increased by a preset power (powerRampStep) 120 using Formula 2. If the terminal does not receive an ACK from the base station again, it retransmits the preamble with a power increased again by the preset power 120 using Formula 2. In this way, the terminal repeatedly retransmits the preamble up to a maximum number (preambleRetransMax) of retransmission with each retransmission being increased in power.

If the terminal does not receive an ACK to the preamble from the base station in spite of retransmissions of the preamble up to the maximum number of retransmissions, it does not further increase the power, but instead calculates an initial preamble power again using Formula 1. The calculated initial preamble power becomes the initial preamble retransmission power of Cycle 2, and the terminal retransmits the preamble with the initial preamble retransmission power. If the terminal does not receive an ACK, it retransmits the preamble up to the maximum number of retransmissions with the power increased as in Formula 2. In this way, the terminal retransmits the preamble up to a maximum number N of cycles. Here, one cycle is a period of time from transmission of a preamble with an initial preamble power or an initial preamble retransmission power to transmission of the preamble with a maximum preamble retransmission power.

As illustrated in FIG. 1, when a terminal does not receive an ACK in spite of retransmissions of a preamble with a maximum preamble retransmission power in Cycle 1, maximum preamble retransmission power sent by the terminal in the following cycles are not significantly different from the maximum preamble retransmission power of Cycle 1. In this case, there is little possibility of receiving an ACK from a base station. In particular, in the case of improper cell planning such as transmission of incorrect system information by a base station or a transmission environment having frequent changes in radio frequency (hereinafter, referred to as ‘RF’), it is almost impossible for a preamble transmitted with the powers increased as in FIG. 1 to successfully reach the base station. Moreover, in the case of frequent changes in RF transmission environment, there occurs a restriction in controlling a power so that a preamble transmitted by a terminal performing an open loop power control for controlling preamble transmission power in the terminal without an interactive operation with a base station can reach the base station. Moreover, as the number of retransmissions of a preamble increases, more power is necessary and more time (setting time) is necessary until data is transmitted through an RACH. This problem becomes more severe as power consumption becomes higher and setting time becomes longer in order to retransmit a preamble in the case of an excessively low initial preamble power. Therefore, it is very important to properly determine an initial preamble power so as to prevent waste of power consumption or setting time.

### SUMMARY OF THE INVENTION

An aspect of the present invention is to address at least the above-mentioned problems and /or disadvantages and to provide at least the advantages described below. Accordingly, an aspect of the present invention provides a method and an apparatus for controlling a power for transmission of a preamble.

In accordance with an aspect of the present invention, a method for controlling power for transmission of a preamble is provided. The method includes calculating an initial preamble transmission power using an initial power calculated using information broadcast through a forward common channel and a stored difference value, transmitting the preamble through a backward common channel with the initial preamble transmission power, retransmitting the preamble with a retransmission power increased by a predetermined power when an acknowledge to the preamble is not received, calculating an initial preamble retransmission power using a power in a case of a maximum number of retransmissions and retransmitting the preamble with the calculated initial preamble retransmission power, when the number of retransmissions exceeds the maximum number of retransmissions and replacing the stored difference value by a difference obtained by subtracting the initial power from the initial preamble retransmission power and storing the obtained difference in place of the stored difference value, when an acknowledge to the preamble retransmitted with the initial preamble retransmission power is received.

In accordance with another aspect of the present invention, an apparatus for controlling power for transmission of a preamble is provided. The apparatus includes a channel receiver for receiving information broadcast through a forward common channel and an acknowledge to the preamble, a channel transmitter for transmitting the preamble through a backward common channel, a radio frequency (RF) transmitter for transmitting the preamble with an initial preamble transmission power, for retransmitting the preamble with a retransmission power when an acknowledge is not received, and for retransmitting the preamble with an initial preamble retransmission power when the number of retransmissions exceeds a maximum number of retransmissions and a control unit for calculating an initial power using the information and for calculating the initial preamble transmission power, the retransmission power, the initial preamble retransmission power, and a difference value.

Until now, characteristics and advantages of the present invention have been briefly described so that any person skilled in the art can easily understand the spirit of the present invention from the following detailed descriptions thereof.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a view illustrating powers for transmissions of a preamble in a conventional system;

FIG. 2 is a view illustrating a network structure of a mobile communication system according to an exemplary embodiment of the present invention;

FIG. 3 is a block diagram illustrating a terminal according to an exemplary embodiment of the present invention;

FIG. 4 is a block diagram illustrating elements for a preamble transmission power device according to an exemplary embodiment of the present invention;

FIGS. 5A and 5B are a flowchart illustrating a process of transmitting a preamble according to an exemplary embodiment of the present invention; and

FIG. 6 is a view illustrating powers with which a terminal transmits a preamble according to an exemplary embodiment of the present invention.

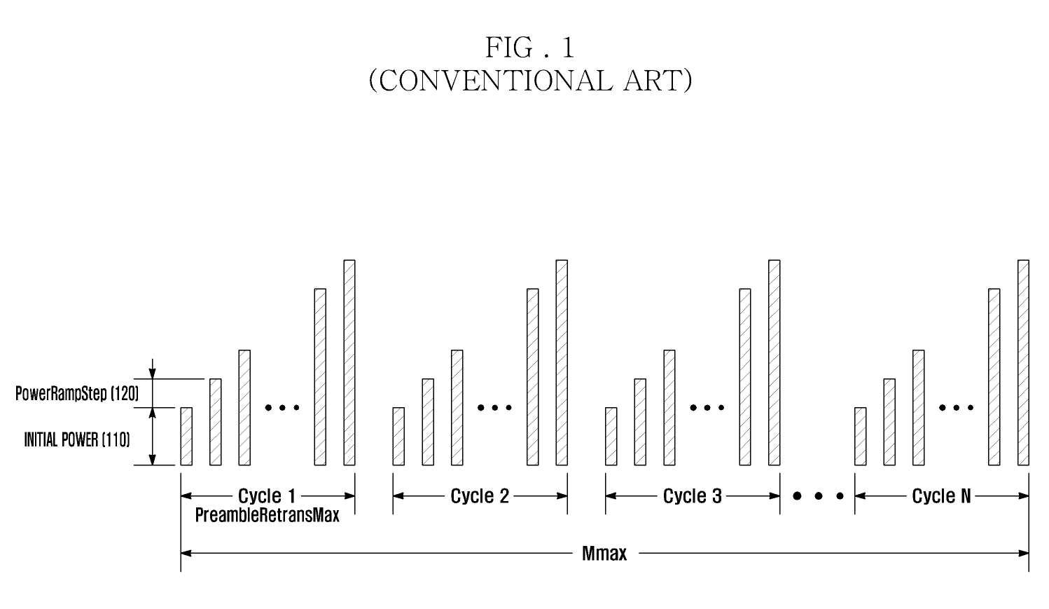

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

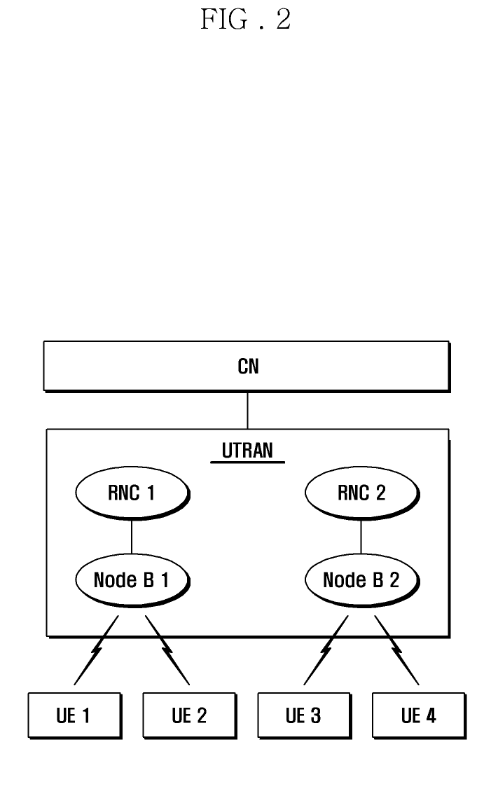

FIG. 2 is a view illustrating a network structure of a mobile communication system according to an exemplary embodiment of the present invention. The mobile communication system is exemplified by a universal mobile telecommunication system (UMTS) using an RACH as a backward common channel.

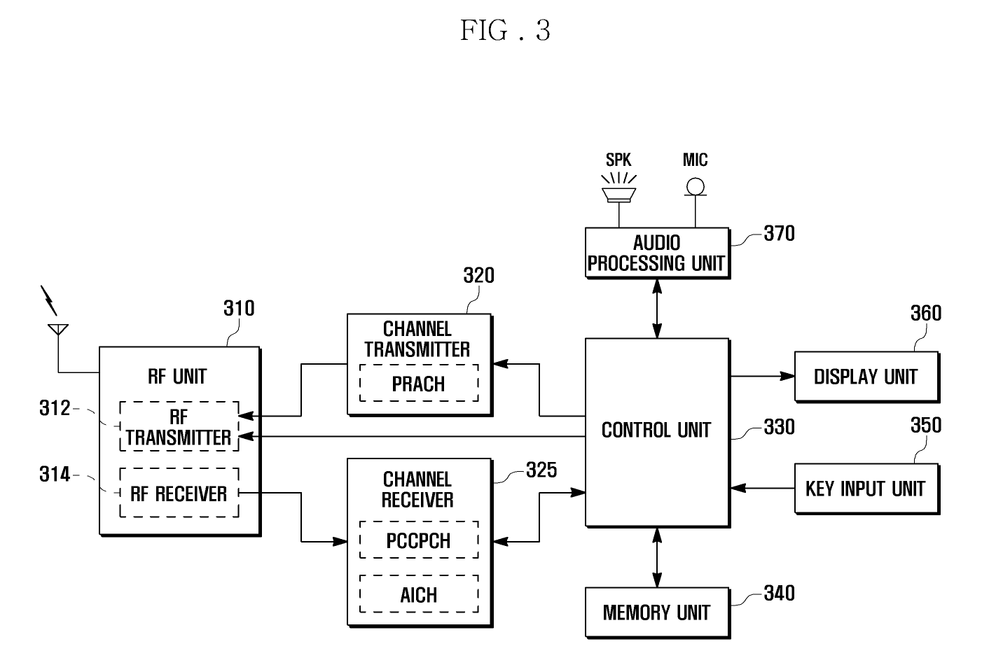

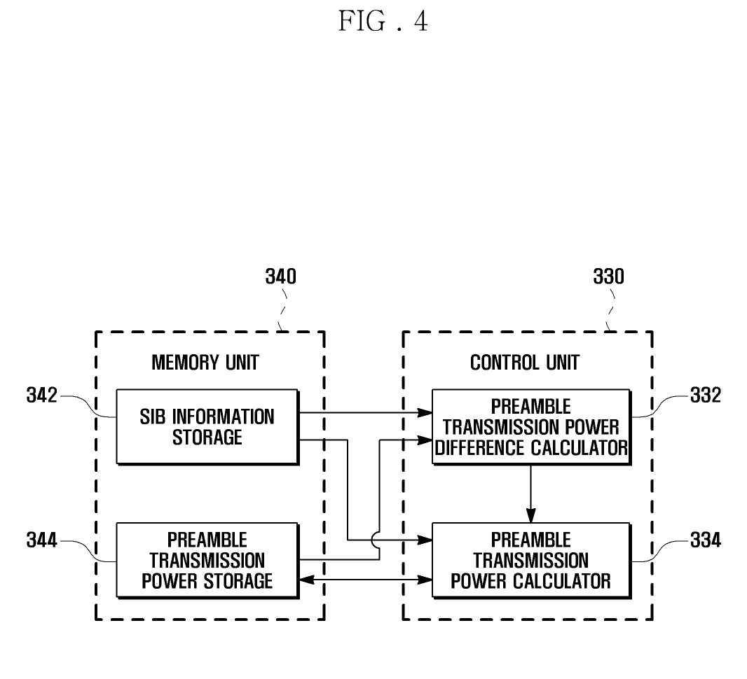

As depicted in FIG. 2, the UMTS system may mainly include user equipment such as terminals UE1, UE2, UE3 and UE4, a UMTS terrestrial radio access network (UTRAN), and a core network (CN). The UTRAN may include at least one radio network controller and at least one node B. In the illustrated example of FIG. 2, the UTRAN is provided with two radio network controllers, RNC 1 and RNC 2 and two node Bs, Node B1 and Node B2. The radio network controllers RNC1 and RNC2 control the node Bs Node B1 and Node B2 respectively. In the following descriptions of exemplary embodiments, a base station refers to substantially the same concept as a UTRAN including radio network controllers and node Bs. Hereinafter, details of UE1 to UE4 controlling power for transmission of preambles will be described in more detail with reference to FIGS. 3 and 4.

FIG. 3 is a block diagram illustrating a terminal according to an exemplary embodiment of the present invention. A terminal may include elements other than those depicted in FIG. 3, but detailed descriptions of elements other than those necessary for transmission of a preamble according to the illustrated example will be omitted.

The following list of terms and their descriptions are provided to assist the reader in an understanding of exemplary embodiments of the present invention which are given below. An initial power refers to an initial power for transmission of a preamble and is calculated from information received from a base station by using a conventional method. An initial preamble transmission power is calculated using a preamble transmission power difference and refers to an initial power for transmission of a preamble according to an exemplary embodiment of the present invention. Retransmission powers refer to powers for retransmissions of a preamble after the initial transmission of the preamble in each cycle, initial preamble retransmission powers refer to powers for initially transmitting a preamble in cycles following an initial cycle (Cycle 1), and maximum preamble retransmission powers refer to powers for finally transmitting a preamble in cycles respectively.

Referring to FIG. 3, an RF unit 310 performs wireless communication of the terminal. The RF unit 310 includes an RF transmitter 312 for up-converting the frequency of a signal to be transmitted and for amplifying the signal and an RF receiver 314 for low noise amplifying a received signal and down-converting the frequency of the received signal. In an exemplary embodiment of the present invention, the RF transmitter 312 amplifies a preamble transmission power of a preamble signal that is to be transmitted from a channel transmitter 320 under the control of a control unit 330 and transmits the amplified preamble transmission power. If an ACK is not received, the power is amplified and then is transmitted under the control of the control unit 330. In an exemplary embodiment of the present invention, a power for transmission of a preamble is calculated using a previously achieved preamble transmission power, a preamble transmission power difference, and a maximum preamble retransmission power in the previous cycle, all of which will be described in detail later.

The channel transmitter 320 transmits a preamble through a physical RACH (PRACH) under the control of the control unit 330 to the RF transmitter 312. The channel transmitter 320 may include a data processor for coding and modulating a transmitted signal. A channel receiver 325 receives a received signal transmitted from the RF receiver 314 under the control of the control unit 330. The channel receiver 325 may include a data processor for demodulating and decoding a received signal. The data processor may include a modulator/demodulator (MODEM) and a coder/decoder (CODEC). The channel receiver 325 receives an SIB broadcast from a base station through a primary common control physical channel (PCCPCH) and receives an ACK to a preamble through an acquisition indication channel (AICH).

The control unit 330 controls overall operations of the terminal. In the illustrated example, the terminal includes the channel receiver 320, the channel receiver 325, and the control unit 330 separately, but they may be integrated into one. According to an exemplary embodiment of the present invention, the control unit 330 calculates an initial preamble transmission power for initial transmission of a preamble using a preamble transmission power difference and controls the RF transmitter 312 to transmit a preamble with the initial preamble transmission power. If the terminal does not receive an ACK to the preamble, the control unit 330 controls the RF transmitter 312 to repeat transmissions of the preamble by increasing the power by a preset amount. If the terminal does not receive an ACK to the preamble from a base station in spite of retransmissions of the preamble up to a maximum number of retransmission times, the control unit 330 calculates an initial preamble retransmission power using the initial preamble transmission power and the maximum preamble retransmission power in the previous cycle, and controls the RF transmitter 312 to retransmit the preamble with the initial preamble retransmission power.

A memory unit 340 may include a program memory and a data memory. The program memory stores operation programs of the terminal and the data memory stores data generated during the execution of programs. The memory unit 340 stores SIB information received from a base station, and stores powers necessary for calculation of powers for transmission of a preamble. They will be described in more detail below with reference to FIG. 4.

A key input unit 350 includes keys for inputting number and letter information and function keys for setting various functions. A user can input data that is to be transmitted to a base station through the keys of the key input unit 350. A display unit 360 displays various menus related to operations of the terminal, applications, and content and displays various data output from the control unit 330. The display unit 360 may use an LCD window, in which case it may include an LCD controller, a memory for storing display data, and an LCD display device. Also, the LCD window may be realized as a touch screen and therefore operated as an input unit. An audio processing unit 370 may include an audio codec, in which case it converts a digital audio signal received by the channel receiver 325 to an analog signal through the audio codec under the control of the control unit 330 and transmits the audio signal to the channel transmitter 320 or to a speaker. The audio codec may be separately provided to the audio processing unit 370, or may be provided together with a data codec. Data may be input through a microphone to be transmitted to a base station.

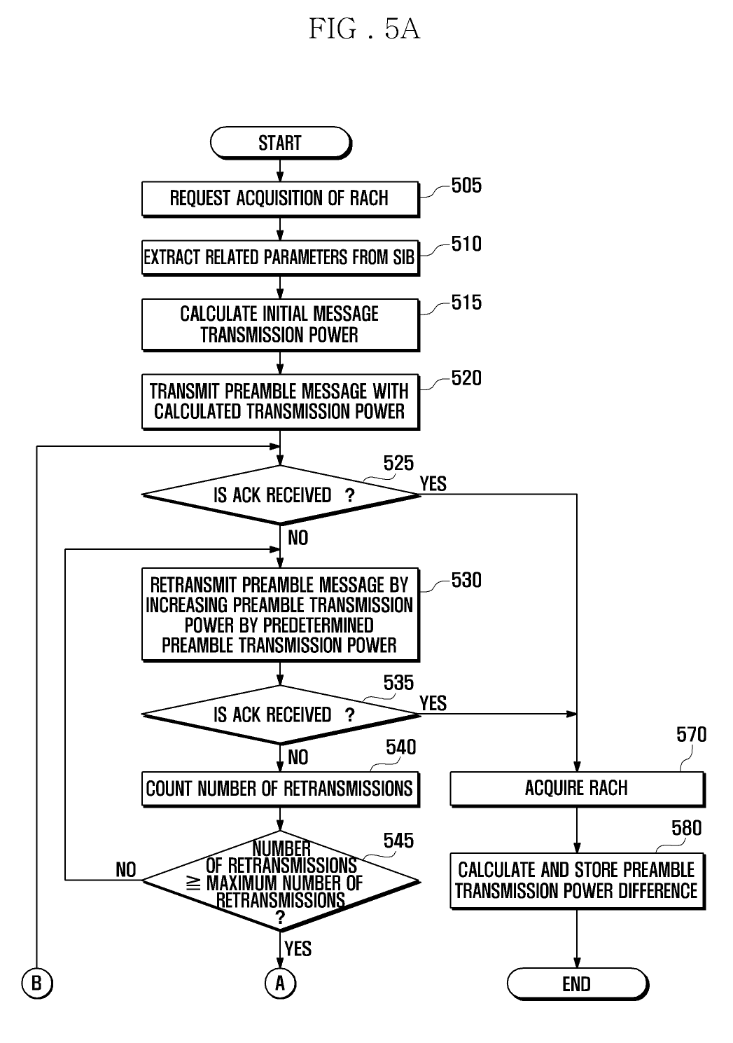

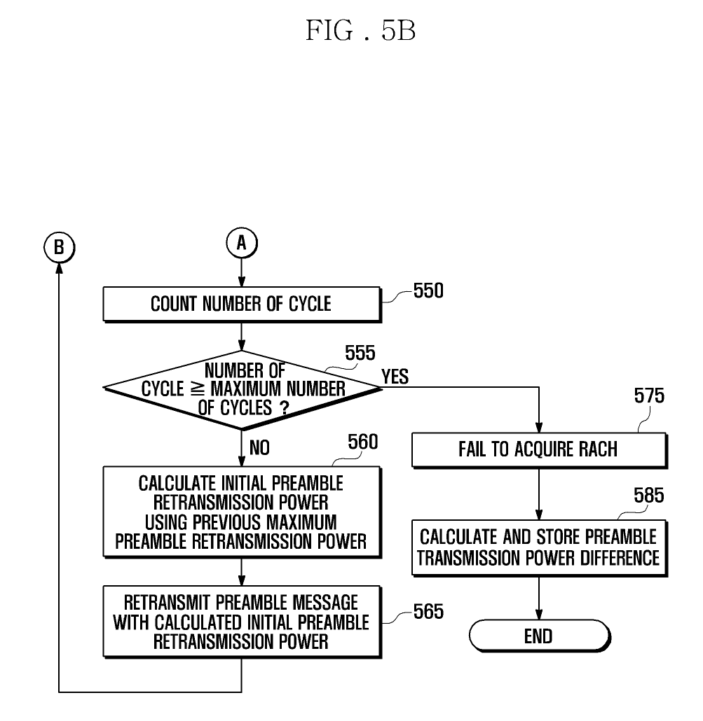

FIG. 4 is a block diagram illustrating elements for a preamble transmission power device according to an exemplary embodiment of the present invention. The memory unit 340 includes an SIB information storage 342 and a preamble transmission power storage 344. The control unit 330 includes a preamble transmission power difference calculator 332 and a preamble transmission power calculator 334. The operations of the elements will be described in detail with reference to FIGS. 5A and 5B. FIGS. 5A and 5B are a flowchart illustrating a process of transmitting a preamble according to an embodiment of the present invention.

Referring to FIGS. 4, 5A and 5B, when data for transmission of a preamble to a base station through an RACH is generated, that is, there occurs a request for acquisition of an RACH in step 505, the control unit 330 extracts parameters necessary for calculation of a power for transmission of a preamble from an SIB in step 510. That is, the SIB is stored in the SIB information storage 342, and the control unit 330 is provided with the parameters necessary for calculation of a power for transmission of a preamble from the SIB information storage in step 510. In step 515, the control unit 330, in particular, the preamble transmission power calculation calculator 334 calculates an initial preamble transmission power (Initial-preamble-Tx-Power). The initial preamble transmission power is calculated in Formula 3 using an initial preamble power calculated using parameters provided from the SIB information storage, such as primaryCPICH-TX-Power, ul-Interference, and constantValue, and a preamble transmission power difference stored in the preamble transmission storage 344 as follows.

Initial-preamble-Tx-Power=Initial-Preamble-Power+PreamblePowerDiff/n Formula 3

where, n is a constant.

The initial preamble power (Initial-Preamble-Power) in Formula 3 is calculated using Formula 1, and the preamble transmission power difference (PreamblePowerDiff) is provided from the preamble transmission power storage 344. As mentioned above, the initial preamble power is recalculated in every cycle using information transmitted from a base station, in which case the initial preamble transmission power is also recalculated in every cycle. Therefore, the initial preamble transmission power may be different in every cycle. As depicted in FIGS. 5A and 5B, for example, the preamble transmission power difference is calculated after acquisition of an RACH or failed acquisition of an RACH and is stored in the preamble transmission power storage 344 in step 580 or 585. More details of these specific processes will be described below. In an exemplary implementation, it is assumed that the preamble transmission power difference is initialized to an initial value and is reinitialized to an initial value if the base station providing service to the terminal is changed. In an exemplary embodiment of the present invention, the initial value is assumed to be zero.

As can be seen in Formula 3, the initial preamble transmission power is a sum of the initial preamble power and a value obtained by dividing the preamble power difference by n. The value of n may be any set constant, and preferably may be two. The initial preamble transmission power may be stored in the preamble transmission power storage 344.

In step 520, the control unit 330 controls the RF transmitter 312 of FIG. 3 to transmit a preamble with the calculated initial preamble transmission power. It should be noted that the preamble transmission power difference may be calculated prior to the step 520 or concurrently therewith. In step 525, the control unit 330 determines whether the terminal receives an ACK to the preamble. If the terminal receives an ACK, the control unit 330 determines that an RACH is acquired in the step 570. If the terminal does not receive an ACK, the control unit 330 proceeds to step 530.

In step 530, the control unit 330, in particular, the preamble transmission power calculator 334 calculates a preamble retransmission power in Formula 4 using the parameters provided from the SIB information storage 342. The control unit 330 controls the RF transmitter 312 to retransmit the preamble with the calculated preamble retransmission power.

P(n)=Initial-Preamble-Tx-Power+powerRampStep×(n−1), (0<n≦preambleRetransMax) Formula 4

In step 535, the control unit 330 determines whether the terminal receives an ACK to the preamble. If the terminal receives an ACK to the preamble, the control unit 330 determines that an RACH is acquired in step 570. If the terminal does not receive an ACK to the preamble, the control unit 330 proceeds to step 540. In step 540, the control unit 330 counts the number of retransmissions by adding one to the previous number of retransmissions. In step 545, the control unit 330 determines whether the number of retransmissions is equal to or more than a maximum number of retransmissions (preambleRetransMax). The maximum number of retransmissions is contained in the SIB, and is received by a base station through a forward common channel. If the number of retransmissions is less than the maximum number of retransmissions, the control unit 330 returns to step 530 to retransmit the preamble with the calculated power described with respect to FIG. 4. If the number of retransmissions is equal to or more than the maximum number of retransmissions, the control unit proceeds to step 550. Then, the control unit 330 stores the preamble transmission power in the case in which the number of retransmissions is equal to the maximum number of retransmissions in the preamble transmission power storage 344, as the maximum preamble retransmission power.

In step 550, the control unit 330 counts the number of cycles by adding one to the previous number of cycles. Here, one cycle is a period of time from transmission of a preamble with an initial preamble power or an initial preamble retransmission power to transmission of the preamble with a maximum preamble retransmission power. In step 555, the control unit 330 determines whether the number of cycles is equal to or more than a maximum number of cycles. The maximum number of cycles is contained in the SIB and is received from the base station. If the number of cycles is less than the maximum number of cycles, the control unit 330 proceeds to step 560, and if the number of cycles is equal to or more than the maximum number of cycles, the control unit 330 proceeds to step 575. In step 575, the control unit 330 determines that the terminal fails to acquire an RACH since it is the case in which the terminal does not receive an ACK in spite of transmissions of the preamble by the maximum number of cycles.

When the terminal does not receive an ACK from the base station in spite of retransmissions by the maximum number of retransmissions, the control unit 330, in particular, the preamble transmission power calculator 334 calculates an initial preamble retransmission power for retransmission of the preamble in the next cycle in the step 560. The preamble transmission power calculator 334 calculates an initial preamble retransmission power (Initial-Preamble-ReTx-Power) in Formula 5 by using the initial preamble transmission power calculated in Formula 3 and the maximum preamble retransmission power in the previous cycle that is provided from the preamble transmission power storage 344. In Formula 5, a parameter RetransMax-Power(Cycle N−1) is a maximum preamble retransmission power in a cycle immediately previous to a current cycle starting an initial retransmission of the preamble, and a parameter Initial-Preamble-Tx-Power(CycleN−1) is an initial preamble transmission power in the previous cycle. The value of N is equal to or less than a maximum number of cycles (Mmax).

Initial-Preamble-ReTx-Power=Initial-Preamble-Tx-Power+{RetransMax-Power(CycleN−1)−initial-Preamble-Tx-Power(CycleN−1)}/n Formula 5

where, n is a constant.

In step 565, the control unit 330 controls the RF transmitter 312 to retransmit the preamble with an initial preamble retransmission power. The control unit 330 returns to the step 525 and determines whether the terminal receives an ACK to the preamble.

In step 570, the control unit 330, in particular the preamble transmission difference calculator 322, determines whether the terminal acquires an RACH, and in step 580, the control unit 330 calculates a preamble transmission power difference (PreamblePowerDiff) using the preamble transmission power in the case of acquisition of the RACH and stores the calculated preamble transmission power difference in the preamble transmission power storage 344. The preamble transmission power difference is calculated by subtracting the initial preamble power from a successful value in transmission of a preamble.

In step 575, the control unit 330, in particular the preamble transmission power difference calculator 332, determines that the terminal fails to acquire an RACH, and in step 585, the control unit 330 calculates a preamble transmission power difference by using a preamble transmission power (hereinafter, referred to as ‘failed maximum preamble transmission power’) with which the preamble is finally transmitted. That is, using the maximum preamble transmission power in the maximum cycle (Cycle N), and stores the calculated preamble transmission power difference in the preamble transmission power storage 344. The preamble transmission power difference is calculated by subtracting the initial power from the failed maximum preamble transmission power.

The calculated and stored preamble transmission power difference is used in calculation of an initial preamble transmission power when the terminal transmits a new preamble. One of the preamble transmission power difference calculated and stored in step 580 and the preamble transmission power difference calculated and stored in step 585 that is finally stored before transmission of a new preamble is provided from the preamble transmission power storage 344 as a preamble transmission power difference to calculate an initial preamble transmission power.

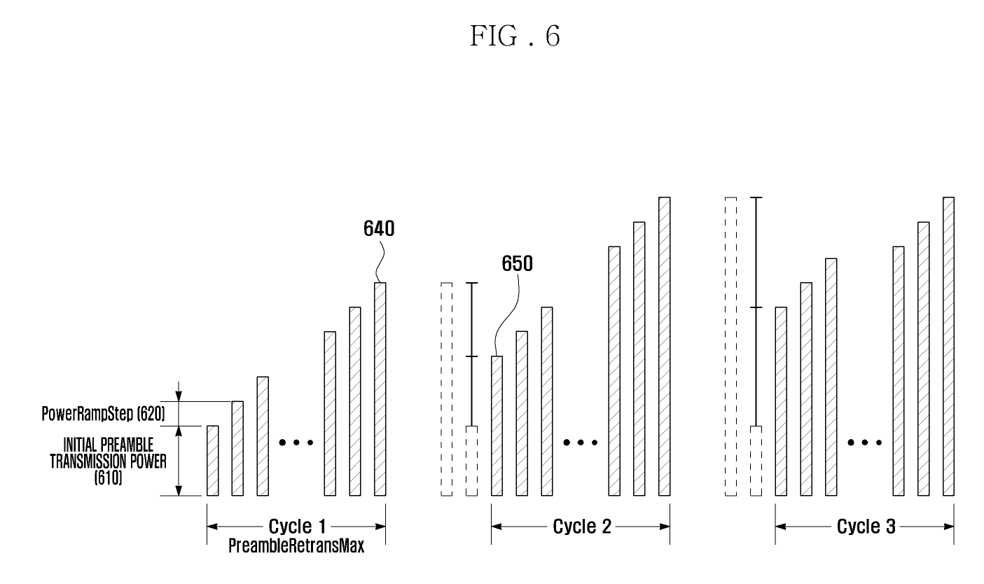

Changes in powers with which the terminal transmits a preamble in the above-mentioned method will be described with reference to FIG. 6. FIG. 6 is a view illustrating powers with which a terminal transmits a preamble according to an exemplary embodiment of the present invention.

Referring to FIG. 6, an initial preamble transmission power 610 represents an initial preamble transmission power calculated using Formula 3. After the control unit 330 of FIG. 3 or FIG. 4 transmits a preamble with the initial preamble transmission power 610, it determines whether the terminal receives an ACK to the preamble. If the terminal does not receive an ACK, the control unit 330 retransmits the preamble with a preamble retransmission power increased by a predetermined power (powerRampStep) 620 using Formula 4. If the terminal still does not receive an ACK, the control unit 330 repeatedly retransmits the preamble until the terminal receives an ACK, by increasing the preamble retransmission power by the predetermined power using Formula 4. The number of retransmissions of the preamble does not exceed a maximum number of retransmissions. A process of retransmitting the preamble up to the maximum number of retransmissions is regarded as one cycle (Cycle 1). The power in the case of the maximum number of retransmissions is regarded as the maximum preamble retransmission power 640 in Cycle 1.

If the terminal still does not receive an ACK in spite of retransmitting the preamble up to the maximum number of retransmissions, the control unit 330 calculates an initial preamble retransmission power 650 using Formula 1 and Formula 5. The initial preamble retransmission power 650 is a sum of the initial preamble transmission power 610 in the previous cycle, i.e. Cycle 1 and a value dividing the difference between the maximum preamble retransmission power 640 in Cycle 1 and the initial preamble transmission power 610 by two. After the control unit 330 transmits the preamble with the initial preamble retransmission power 650, it determines whether the terminal receives an ACK to the preamble. If the terminal still does not receive an ACK, the control unit 330 repeatedly retransmits the preamble with a preamble retransmission power increased by the predetermined power using Formula 4. The control unit 330 repeats transmitting the preamble up to the maximum number of cycles contained in the SIB. Accordingly, the terminal transmits a preamble with a preamble transmission power increased by a predetermined power using an initial preamble transmission power in a previous cycle that is based on a previously successful preamble transmission power and an initial preamble retransmission power that is based on the maximum preamble retransmission power in the previous cycle.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for controlling power for transmission of a preamble, the method comprising:
calculating an initial preamble transmission power using an initial power calculated using information broadcast through a forward common channel and a stored difference value;
transmitting the preamble through a backward common channel with the initial preamble transmission power; and
replacing the stored difference value by a difference obtained by subtracting the initial power from the initial preamble transmission power and storing the obtained difference in place of the stored difference value, when an acknowledge to the preamble is received.

2. The method of claim 1, wherein the initial preamble transmission power comprises a sum of values obtained by dividing the initial power and the difference by a constant n.

3. The method of claim 2, further comprising:
initializing the stored difference value to a predetermined initial value; and
storing the difference value when a base station providing service is changed, wherein the predetermined initial value is zero.

4. The method of claim 3, further comprising:
retransmitting the preamble with a retransmission power increased by a predetermined power, when an acknowledge to the preamble is not received; and
storing a difference obtained by subtracting the initial power from a retransmission power when an acknowledge to the retransmitted preamble is received.

5. The method of claim 4, wherein the retransmission power comprises a sum of the initial preamble transmission power and a value obtained by multiplying the predetermined power by the number of the previous retransmissions.

6. The method of claim 5, further comprising calculating the initial power using parameters contained in a system information block (SIB) regarding information broadcast from the base station.

7. A method for controlling power for transmission of a preamble, the method comprising:
calculating an initial preamble transmission power using an initial power calculated using information broadcast through a forward common channel and a stored difference value;
transmitting the preamble through a backward common channel with the initial preamble transmission power;
retransmitting the preamble with a retransmission power increased by a predetermined power when an acknowledge to the preamble is not received;
calculating an initial preamble retransmission power using a power in a case of a maximum number of retransmissions and retransmitting the preamble with the calculated initial preamble retransmission power, when the number of retransmissions exceeds the maximum number of retransmissions; and
replacing the stored difference value by a difference obtained by subtracting the initial power from the initial preamble retransmission power and storing the obtained difference in place of the stored difference value, when an acknowledge to the preamble retransmitted with the initial preamble retransmission power is received.

8. The method of claim 7, wherein the initial preamble retransmission power comprises a sum of a value obtained by dividing a value obtained by subtracting the initial preamble transmission power from a power in a case of the maximum number of retransmissions by a constant n, and the initial preamble transmission power.

9. The method of claim 8, further comprising:
initializing the stored difference value to a predetermined initial value; and
storing the difference value, when a base station providing service is changed.

10. The method of claim 8, wherein the initial preamble transmission power comprises a sum of values obtained by dividing the initial power and the difference by a constant n.

11. The method of claim 10, wherein the retransmission power comprises a sum of the initial preamble transmission power and a value obtained by multiplying the predetermined power by the number of the previous retransmissions.

12. The method of claim 11, wherein the calculating of the initial power comprises using parameters contained in a system information block (SIB) regarding information broadcast from a base station.

13. The method of claim 7, further comprising:
determining whether the number of cycles exceeds a maximum number of cycles, when the number of retransmissions does not exceed a maximum number of retransmissions; and
storing a difference obtained by subtracting the initial power from a maximum preamble retransmission power in a maximum cycle, when the number of cycles exceeds the maximum number of cycles.

14. An apparatus for controlling power for transmission of a preamble , the apparatus comprising:
a channel receiver for receiving information broadcast through a forward common channel and an acknowledge to the preamble;
a channel transmitter for transmitting the preamble through a backward common channel;
a radio frequency (RF) transmitter for transmitting the preamble with an initial preamble transmission power, for retransmitting the preamble with a retransmission power when an acknowledge is not received, and for retransmitting the preamble with an initial preamble retransmission power when the number of retransmissions exceeds a maximum number of retransmissions; and
a control unit for calculating an initial power using the information and for calculating the initial preamble transmission power, the retransmission power, the initial preamble retransmission power, and a difference value.

15. The apparatus of claim 14, wherein the control unit comprises a difference calculator for calculating the initial power using the broadcast information and for calculating the difference value by subtracting the initial power from one of a preamble transmission power in a case of receiving an acknowledge to the preamble and a preamble transmission power in a case of not receiving an acknowledge to the preamble.

16. The apparatus of claim 15, wherein the control unit comprises a preamble transmission power calculator for calculating the initial preamble transmission power using the initial power and the difference value, for calculating the retransmission power by increasing the initial preamble transmission power by a predetermined power, and for calculating the initial preamble retransmission power using the maximum preamble retransmission power.

17. The apparatus of claim 16, wherein the initial preamble transmission power comprises a sum of values obtained by dividing the initial power and the difference by a constant n.

18. The apparatus of claim 17, wherein the retransmission power comprises a sum of the initial preamble transmission power and a value obtained by multiplying the predetermined power by the number of the previous retransmissions.

19. The apparatus of claim 18, wherein the initial preamble retransmission power comprises a sum of a value obtained by dividing a value obtained by subtracting the initial preamble transmission power from a preamble transmission power in a case of the maximum number of retransmissions by a constant n and the initial preamble transmission power.

20. The apparatus of claim 19, wherein the initial power is calculated using parameters contained in a system information block (SIB) regarding information broadcasted from a base station.

21. The apparatus of claim 20, wherein a preamble transmission power in a case of not receiving an acknowledge to the preamble is a maximum preamble retransmission power in a maximum cycle in a case of not receiving an acknowledge to the preamble after retransmission of the preamble by the maximum number of retransmissions in the maximum cycle.

22. The apparatus of claim 21, further comprising a storage unit for storing the broadcast information, the maximum preamble retransmission power, and the difference value.
